(19) United States
(12) Patent Application Publication
(10) Pub. No.: US 2016/0125535 A1
(43) Pub. Date: May 5, 2016

(54) LOCATION-AWARE RISK MITIGATION SYSTEMS AND METHODS

(71) Applicant: TRADING TECHNOLOGIES INTERNATIONAL INC., Chicago, IL (US)

(72) Inventor: Scott F. Singer, Green Oaks, IL (US)

(21) Appl. No.: 14/530,512

(22) Filed: Oct. 31, 2014

(51) Int. Cl. G06Q 40/04

(52) U.S. Cl. CPC G06Q 40/04

(57) ABSTRACT

Certain examples provide systems and methods to determine and respond to trader location. An example method includes monitoring, using feedback from one or more detection devices, a location of a trader with respect to a trading device associated with the trader. The example method includes assigning a presence state to the trader based on the monitored location of the trader. The example method includes comparing the presence state of the trader with a risk threshold. The example method includes triggering a risk mitigation strategy including one or more risk mitigation actions, wherein the selected risk mitigation action is determined based on the comparison between the presence state of the trader and the risk threshold.

### BACKGROUND

An electronic trading system generally includes a trading device in communication with an electronic exchange. The trading device receives information about a market, such as prices and quantities, from the electronic exchange. The electronic exchange receives messages, such as messages related to orders, from the trading device. The electronic exchange attempts to match quantity of an order with quantity of one or more contra-side orders.

Electronic exchanges have made it possible for an increasing number of participants to be active in a market at any given time. The increase in the number of potential market participants has led to, among other things, a more competitive market and greater liquidity. In the competitive environment of electronic trading, where every second or a fraction of second counts in intercepting trading opportunities.

### BRIEF DESCRIPTION OF THE FIGURES

Certain embodiments are disclosed with reference to the following drawings.

FIG. 1 illustrates a block diagram representative of an example electronic trading system in which certain embodiments may be employed.

FIG. 2 illustrates a block diagram of another example electronic trading system in which certain embodiments may be employed.

FIG. 3 illustrates a block diagram of an example computing device which may be used to implement the disclosed embodiments.

FIG. 4 illustrates an example system including a risk administrator device in communication with a trading device, a gateway, and an exchange.

FIG. 5 illustrates an example area in which the trading device may be located.

FIG. 6 illustrates a flow diagram of an example method to mitigate risk in an electronic trading system.

FIG. 7 illustrates a flow diagram of an example risk mitigation strategy.

FIGS. 8A and 8B illustrate a flow diagram of an example method for user presence detection and status notification.

FIG. 9 illustrates an example system including a suite of presence detectors interacting with a monitoring application to track and provide a status update regarding a trader's location with respect to a trading device.

FIG. 10 is a block diagram of an example system that can implement and/or execute the example operations of FIGS. 5-9.

Certain embodiments will be better understood when read in conjunction with the provided figures, which illustrate examples. It should be understood, however, that the embodiments are not limited to the arrangements and instrumentality shown in the attached figures.

### DETAILED DESCRIPTION

Exchanges facilitate transactions between users of a marketplace wanting to, for example, buy or sell one or more tradeable objects. An order submitted to an exchange is, for example, a buy order or a sell order for a given tradeable object. The exchange attempts to match received orders with contra-side orders available in a corresponding market. For example, to fulfill a received buy order for a tradeable object, the exchange attempts to match the received buy order with a received or resting sell order working in the market for the tradeable object. Similarly, to fulfill a received sell order for the tradeable object, the exchange attempts to match the received sell order with a received or resting buy order working in the market for the tradeable object. The exchange can evaluate a level of risk or risk tolerance associated with the order and/or the trader placing the order, for example. The exchange then processes the order in accordance with the current conditions of the market. To process the trade orders, the exchange executes and/or facilitates a plurality of calculations, transactions, and communications.

In general, a market participant desires to be able to react more quickly than other market participants. For example, a market participant such as a trader, a trading application or algorithm generally desires to be “first-to-market” (e.g., have trade orders entered prior to other market participants entering the same or similar orders). It is therefore desirable to improve the way market data is displayed to the market participant and to allow the market participant to make fast and accurate order entry. The slightest speed advantage may give a market participant a significant competitive advantage.

Trading applications allow market participants to initiate trade actions via a trading device. In some examples, a trading application may present a user interface including a trading window(s) or trading screen(s) to display market data or a portion of the market data. In addition, the trading window may include a trade action control to initiate or execute a trade action. A trade action control is a button, a cell, or an area on a trading window that corresponds to a particular trade action. In some examples, when a trade action control is selected or otherwise enabled, the trading device may execute or perform the corresponding trade action, such as placing, cancelling or changing a trade order.

Risk management refers to a process of identification, analysis and either acceptance or mitigation of uncertainty in trading, for example. Risk management can be based on a desired trade (e.g., potential for gain, potential for loss, investment objective, risk tolerance, etc.) and/or a trader seeking to make a trade (e.g., experienced, inexperienced, history of success, history of losses, trader rating/ranking, spending limit, etc.). If risk management is improper or lacking, traders, companies, and/or exchanges can suffer consequences.

A risk manager or risk administrator for a trading system helps ensure that traders operate according to parameters specified by risk administrators, who, in turn, are able to access information to maintain control. For example, a risk administrator can define and maintain a position limit, an order type limit, an exchange limit, a cash limit, initial and variation margin limits, fill limit, live order cancellation, trading display for each trader, or group of traders, that they manage and/or oversee.

For example, a risk manager can be used to define a trader's permissions and/or trading parameters, such as specifying order type(s) a trader can utilize, product(s) the trader can access, monetary limits, quantity limits, etc. One or more risk limits can be defined with threshold values configured to activate a response such as issue alerts, halt trades, etc., in response to encountering one of the limits. A response may be triggered when a measured value equals or exceeds a threshold value. Additional responses may be triggered upon detection of other user-defined events such as a market announcement, encountering a range or zone around one of the limits or other combinations of quantifiable events. In certain embodiments, the risk manager can evaluate an operating state of one or more exchanges, monitor trading activity, and highlight a risk level or status of traders. The risk manager may further be configured to specify and manage the risk controls that define the position and limits of both individual traders as well as multiple traders having different and/or configurable individual permissions and/or parameters.

Risk controls can be configured by a risk administrator. Risk controls can facilitate control over one or more aspects of a user's trading such as a) whether a user is enabled to submit orders, b) an amount of money the user is allowed to lose and continue to trade (including margin and additional margin values), c) products and product types that the user can trade, d) maximum size of a single order, e) maximum long or short position for a product, 0 other administrator-defined condition.

Certain examples relate to risk mitigation facilitated using a determination of a location and/or presence of a trader with respect to a trading device. Based on trader location (e.g., presence at or proximity to a trader workstation) provided by one or more detection devices, a notification can be provided to a risk administrator, the trader, and/or other user in the event of or in advance of a market event that poses a risk to a position held by the trader. Based on trader location and market condition, an appropriate/possible response (or responses) can be provided (e.g., to the risk administrator, to the trader in question, and/or to a designated alternate trader).

### I. Brief Description of Certain Embodiments

Certain embodiments provide a method. The example method includes monitoring, using feedback from one or more detection devices, a location of a trader with respect to a trading device associated with the trader. The example method includes assigning, using a processor, a presence state to the trader based on the monitored location of the trader. The example method includes comparing, using the processor, the presence state of the trader with a risk threshold. The example method includes triggering, using the processor, a risk mitigation strategy including one or more risk mitigation actions, such as a notification to a risk administrator, automatic trade(s), etc., based on the comparison between the presence state of the trader and the risk threshold. Options provided by the risk mitigation strategy may be updated and/or refined based on repeated queries to the detection devices in order to determine the current presence state of the trader. In other examples, the current presence state of the trader can be pushed and/or periodically communicated to the risk administrator for use in a risk mitigation strategy.

Certain embodiments provide a tangible computer-readable storage medium including computer program instructions which, when executed by a processor, perform a method. The example method performed includes monitoring, using feedback from one or more detection devices, a location of a trader with respect to a trading device associated with the trader. The example method includes assigning, using the processor, a presence state to the trader based on the monitored location of the trader. The example method includes comparing, using the processor, the presence state of the trader with a risk threshold. The example method includes triggering, using the processor, a risk mitigation strategy including one or more risk mitigation actions, such as a notification to a risk administrator, automatic trade(s), etc., based on the comparison between the presence state of the trader and the risk threshold.

Certain embodiments provide a system. The example system includes a trading device configured to execute a trade order, the trading device in communication with one or more detection devices to provide a location of a trader, the trading device including a processor and a memory to execute instructions stored thereon. The example processor executes the instructions to monitor, using feedback from the one or more detection devices, a location of a trader with respect to a trading device associated with the trader. The example processor executes the instructions to assign, using the processor, a presence state to the trader based on the monitored location of the trader. The example processor executes the instructions to compare, using the processor, the presence state of the trader with a risk threshold. The example processor executes the instructions to trigger, using the processor, a risk mitigation strategy including one or more risk mitigation actions, such as a notification to a risk administrator, automatic trade(s), etc., based on the comparison between the presence state of the trader and the risk threshold.

### II. Example Electronic Trading System

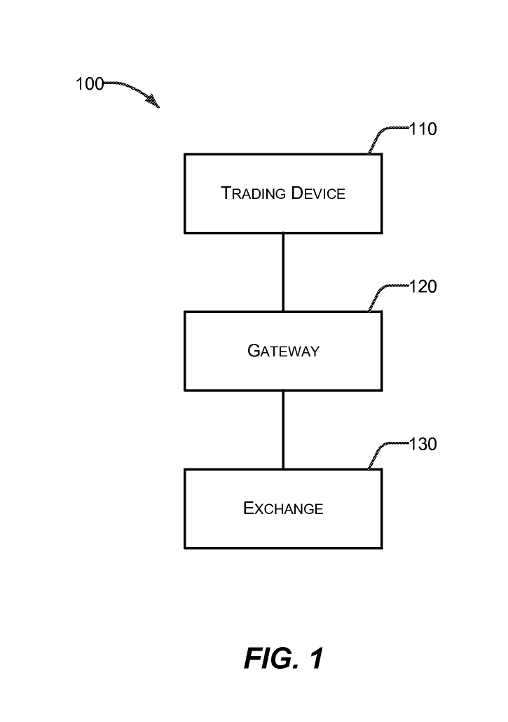

FIG. 1 illustrates a block diagram representative of an example electronic trading system 100 in which certain embodiments may be employed. The system 100 includes a trading device 110, a gateway 120, and an exchange 130. The trading device 110 is in communication with the gateway 120. The gateway 120 is in communication with the exchange 130. As used herein, the phrase “in communication with” encompasses direct communication and/or indirect communication through one or more intermediary components. The exemplary electronic trading system 100 depicted in FIG. 1 may be in communication with additional components, subsystems, and elements to provide additional functionality and capabilities without departing from the teaching and disclosure provided herein.

In operation, the trading device 110 may receive market data from the exchange 130 through the gateway 120. A user may utilize the trading device 110 to monitor this market data and/or base a decision to send an order message to buy or sell one or more tradeable objects to the exchange 130.

Market data may include data about a market for a tradeable object. For example, market data may include the inside market, market depth, last traded price (“LTP”), a last traded quantity (“LTQ”), or a combination thereof. The inside market refers to the highest available bid price (best bid) and the lowest available ask price (best ask or best offer) in the market for the tradeable object at a particular point in time (since the inside market may vary over time). Market depth refers to quantities available at price levels including the inside market and away from the inside market. Market depth may have “gaps” due to prices with no quantity based on orders in the market.

The price levels associated with the inside market and market depth can be provided as value levels which can encompass prices as well as derived and/or calculated representations of value. For example, value levels may be displayed as net change from an opening price. As another example, value levels may be provided as a value calculated from prices in two other markets. In another example, value levels may include consolidated price levels.

A tradeable object is anything which may be traded. For example, a certain quantity of the tradeable object may be bought or sold for a particular price. A tradeable object may include, for example, financial products, stocks, options, bonds, future contracts, currency, warrants, funds derivatives, securities, commodities, swaps, interest rate products, index-based products, traded events, goods, or a combination thereof. A tradeable object may include a product listed and/or administered by an exchange, a product defined by the user, a combination of real or synthetic products, or a combination thereof. There may be a synthetic tradeable object that corresponds and/or is similar to a real tradeable object.

An order message is a message that includes a trade order. A trade order may be, for example, a command to place an order to buy or sell a tradeable object; a command to initiate managing orders according to a defined trading strategy; a command to change, modify, or cancel an order; an instruction to an electronic exchange relating to an order; or a combination thereof.

The trading device 110 may include one or more electronic computing platforms. For example, the trading device 110 may include a desktop computer, hand-held device, laptop, server, a portable computing device, a trading terminal, an embedded trading system, a workstation, an algorithmic trading system such as a “black box” or “grey box” system, cluster of computers, or a combination thereof. As another example, the trading device 110 may include a single or multi-core processor in communication with a memory or other storage medium configured to accessibly store one or more computer programs, applications, libraries, computer readable instructions, and the like, for execution by the processor.

As used herein, the phrases “configured to” and “adapted to” encompass that an element, structure, or device has been modified, arranged, changed, or varied to perform a specific function or for a specific purpose.

By way of example, the trading device 110 may be implemented as a personal computer running a copy of X_TRADER®, an electronic trading platform provided by Trading Technologies International, Inc. of Chicago, Ill. (“Trading Technologies”). As another example, the trading device 110 may be a server running a trading application providing automated trading tools such as ADL®, AUTOSPREADER®, and/or AUTOTRADER™, also provided by Trading Technologies. In yet another example, the trading device 110 may include a trading terminal in communication with a server, where collectively the trading terminal and the server are the trading device 110.

The trading device 110 is generally owned, operated, controlled, programmed, configured, or otherwise used by a user. As used herein, the phrase “user” may include, but is not limited to, a human (for example, a trader), trading group (for example, a group of traders), or an electronic trading device (for example, an algorithmic trading system). One or more users may be involved in the ownership, operation, control, programming, configuration, or other use, for example.

The trading device 110 may include one or more trading applications. As used herein, a trading application is an application that facilitates or improves electronic trading. A trading application provides one or more electronic trading tools. For example, a trading application stored by a trading device may be executed to arrange and display market data in one or more trading windows. In another example, a trading application may include an automated spread trading application providing spread trading tools. In yet another example, a trading application may include an algorithmic trading application that automatically processes an algorithm and performs certain actions, such as placing an order, modifying an existing order, deleting an order. In yet another example, a trading application may provide one or more trading screens. A trading screen may provide one or more trading tools that allow interaction with one or more markets. For example, a trading tool may allow a user to obtain and view market data, set order entry parameters, submit order messages to an exchange, deploy trading algorithms, and/or monitor positions while implementing various trading strategies. The electronic trading tools provided by the trading application may always be available or may be available only in certain configurations or operating modes of the trading application.

A trading application may be implemented utilizing computer readable instructions that are stored in a computer readable medium and executable by a processor. A computer readable medium may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable storage media and to exclude propagating signals.

One or more components or modules of a trading application may be loaded into the computer readable medium of the trading device 110 from another computer readable medium. For example, the trading application (or updates to the trading application) may be stored by a manufacturer, developer, or publisher on one or more CDs or DVDs, which are then loaded onto the trading device 110 or to a server from which the trading device 110 retrieves the trading application. As another example, the trading device 110 may receive the trading application (or updates to the trading application) from a server, for example, via the Internet or an internal network. The trading device 110 may receive the trading application or updates when requested by the trading device 110 (for example, “pull distribution”) and/or un-requested by the trading device 110 (for example, “push distribution”).

The trading device 110 may be adapted to send order messages. For example, the order messages may be sent to through the gateway 120 to the exchange 130. As another example, the trading device 110 may be adapted to send order messages to a simulated exchange in a simulation environment which does not effectuate real-world trades.

The order messages may be sent at the request of a user. For example, a trader may utilize the trading device 110 to send an order message or manually input one or more parameters for a trade order (for example, an order price and/or quantity). As another example, an automated trading tool provided by a trading application may calculate one or more parameters for a trade order and automatically send the order message. In some instances, an automated trading tool may prepare the order message to be sent but not actually send it without confirmation from a user.

An order message may be sent in one or more data packets or through a shared memory system. For example, an order message may be sent from the trading device 110 to the exchange 130 through the gateway 120. The trading device 110 may communicate with the gateway 120 using a local area network, a wide area network, a wireless network, a virtual private network, a cellular network, a peer-to-peer network, a T1 line, a T3 line, an integrated services digital network (“ISDN”) line, a point-of-presence, the Internet, a shared memory system and/or a proprietary network such as TTNET™ provided by Trading Technologies, for example.

The gateway 120 may include one or more electronic computing platforms. For example, the gateway 120 may be implemented as one or more desktop computer, hand-held device, laptop, server, a portable computing device, a trading terminal, an embedded trading system, workstation with a single or multi-core processor, an algorithmic trading system such as a “black box” or “grey box” system, cluster of computers, or any combination thereof.

The gateway 120 may facilitate communication. For example, the gateway 120 may perform protocol translation for data communicated between the trading device 110 and the exchange 130. The gateway 120 may process an order message received from the trading device 110 into a data format understood by the exchange 130, for example. Similarly, the gateway 120 may transform market data in an exchange-specific format received from the exchange 130 into a format understood by the trading device 110, for example.

The gateway 120 may include a trading application, similar to the trading applications discussed above, that facilitates or improves electronic trading. For example, the gateway 120 may include a trading application that tracks orders from the trading device 110 and updates the status of the order based on fill confirmations received from the exchange 130. As another example, the gateway 120 may include a trading application that coalesces market data from the exchange 130 and provides it to the trading device 110. In yet another example, the gateway 120 may include a trading application that provides risk processing, calculates implieds, handles order processing, handles market data processing, or a combination thereof.

In certain embodiments, the gateway 120 communicates with the exchange 130 using a local area network, a wide area network, a wireless network, a virtual private network, a cellular network, a peer-to-peer network, a T1 line, a T3 line, an ISDN line, a point-of-presence, the Internet, a shared memory system, and/or a proprietary network such as TTNET™ provided by Trading Technologies, for example.

The exchange 130 may be owned, operated, controlled, or used by an exchange entity. Example exchange entities include the CME Group, the London International Financial Futures and Options Exchange, the Intercontinental Exchange, and Eurex. The exchange 130 may include an electronic matching system, such as a computer, server, or other computing device, which is adapted to allow tradeable objects, for example, offered for trading by the exchange, to be bought and sold. The exchange 130 may include separate entities, some of which list and/or administer tradeable objects and others which receive and match orders, for example. The exchange 130 may include an electronic communication network (“ECN”), for example.

The exchange 130 may be an electronic exchange. The exchange 130 is adapted to receive order messages and match contra-side trade orders to buy and sell tradeable objects. Unmatched trade orders may be listed for trading by the exchange 130. Once an order to buy or sell a tradeable object is received and confirmed by the exchange, the order is considered to be a working order until it is filled or cancelled. If only a portion of the quantity of the order is matched, then the partially filled order remains a working order. The trade orders may include trade orders received from the trading device 110 or other devices in communication with the exchange 130, for example. For example, typically the exchange 130 will be in communication with a variety of other trading devices (which may be similar to trading device 110) which also provide trade orders to be matched.

The exchange 130 is adapted to provide market data. Market data may be provided in one or more messages or data packets or through a shared memory system. For example, the exchange 130 may publish a data feed to subscribing devices, such as the trading device 110 or gateway 120. The data feed may include market data.

The system 100 may include additional, different, or fewer components. For example, the system 100 may include multiple trading devices, gateways, and/or exchanges. In another example, the system 100 may include other communication devices, such as middleware, firewalls, hubs, switches, routers, servers, exchange-specific communication equipment, modems, security managers, and/or encryption/decryption devices.

### III. Expanded Example Electronic Trading System

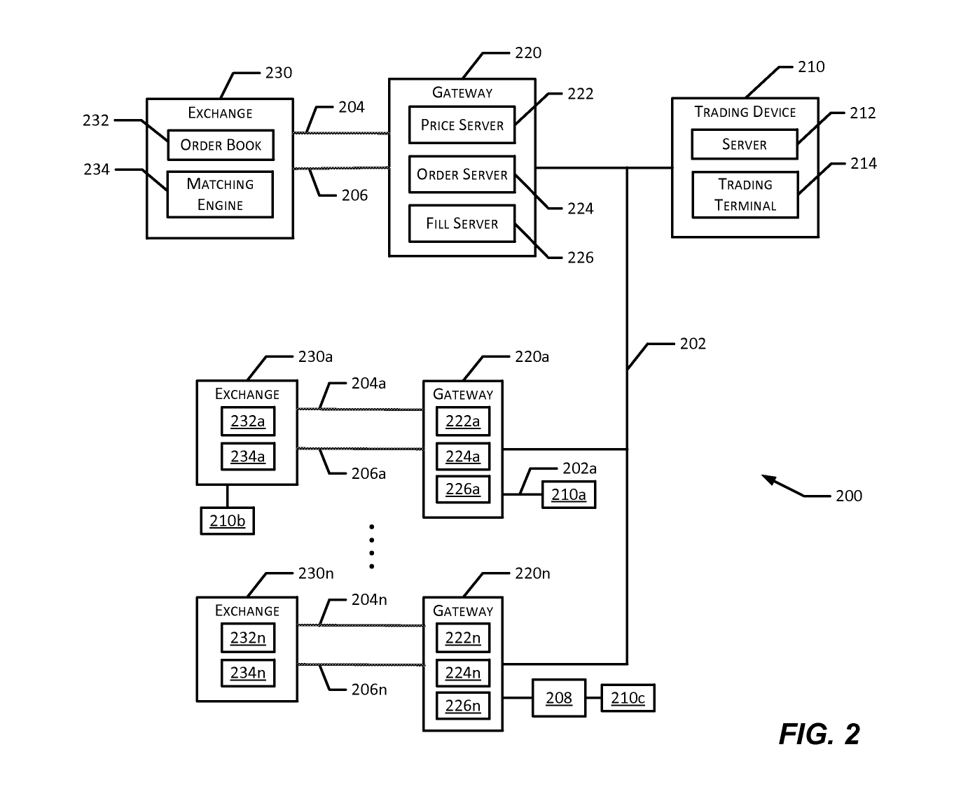

FIG. 2 illustrates a block diagram of another example electronic trading system 200 in which certain embodiments may be employed. In this example, a trading device 210 may utilize one or more communication networks to communicate with a gateway 220 and exchange 230. For example, the trading device 210 utilizes network 202 to communicate with the gateway 220, and the gateway 220, in turn, utilizes the networks 204 and 206 to communicate with the exchange 230. As used herein, a network facilitates or enables communication between computing devices such as the trading device 210, the gateway 220, and the exchange 230.

The following discussion generally focuses on the trading device 210, gateway 220, and the exchange 230. However, the trading device 210 may also be connected to and communicate with “n” additional gateways (individually identified as gateways 220a-220n, which may be similar to gateway 220) and “n” additional exchanges (individually identified as exchanges 230a-230n, which may be similar to exchange 230) by way of the network 202 (or other similar networks). Additional networks (individually identified as networks 204a-204n and 206a-206n, which may be similar to networks 204 and 206, respectively) may be utilized for communications between the additional gateways and exchanges. The communication between the trading device 210 and each of the additional exchanges 230a-230n need not be the same as the communication between the trading device 210 and exchange 230. Generally, each exchange has its own preferred techniques and/or formats for communicating with a trading device, a gateway, the user, or another exchange. It should be understood that there is not necessarily a one-to-one mapping between gateways 220a-220n and exchanges 230a-230n. For example, a particular gateway may be in communication with more than one exchange. As another example, more than one gateway may be in communication with the same exchange. Such an arrangement may, for example, allow one or more trading devices 210 to trade at more than one exchange (and/or provide redundant connections to multiple exchanges).

Additional trading devices 210a-210n, which may be similar to trading device 210, may be connected to one or more of the gateways 220a-220n and exchanges 230a-230n. For example, the trading device 210a may communicate with the exchange 230a via the gateway 220a and the networks 202a, 204a and 206a. In another example, the trading device 210b may be in direct communication with exchange 230a. In another example, trading device 210c may be in communication with the gateway 220n via an intermediate device 208 such as a proxy, remote host, or WAN router.

The trading device 210, which may be similar to the trading device 110 in FIG. 1, includes a server 212 in communication with a trading terminal 214. The server 212 may be located geographically closer to the gateway 220 than the trading terminal 214 in order to reduce latency. In operation, the trading terminal 214 may provide a trading screen to a user and communicate commands to the server 212 for further processing. For example, a trading algorithm may be deployed to the server 212 for execution based on market data. The server 212 may execute the trading algorithm without further input from the user. In another example, the server 212 may include a trading application providing automated trading tools and communicate back to the trading terminal 214. The trading device 210 may include additional, different, or fewer components.

In operation, the network 202 may be a multicast network configured to allow the trading device 210 to communicate with the gateway 220. Data on the network 202 may be logically separated by subject such as, for example, by prices, orders, or fills. As a result, the server 212 and trading terminal 214 can subscribe to and receive data such as, for example, data relating to prices, orders, or fills, depending on their individual needs.

The gateway 220, which may be similar to the gateway 120 of FIG. 1, may include a price server 222, order server 224, and fill server 226. The gateway 220 may include additional, different, or fewer components. The price server 222 may process price data. Price data includes data related to a market for one or more tradeable objects. The order server 224 processes order data. Order data is data related to a user's trade orders. For example, order data may include order messages, confirmation messages, or other types of messages. The fill server collects and provides fill data. Fill data includes data relating to one or more fills of trade orders. For example, the fill server 226 may provide a record of trade orders, which have been routed through the order server 224, that have and have not been filled. The servers 222, 224, and 226 may run on the same machine or separate machines. There may be more than one instance of the price server 222, the order server 224, and/or the fill server 226 for gateway 220. In certain embodiments, the additional gateways 220a-220n may each includes instances of the servers 222, 224, and 226 (individually identified as servers 222a-222n, 224a-224n, and 226a-226n).

The gateway 220 may communicate with the exchange 230 using one or more communication networks. For example, as shown in FIG. 2, there may be two communication networks connecting the gateway 220 and the exchange 230. The network 204 may be used to communicate market data to the price server 222. In some instances, the exchange 230 may include this data in a data feed that is published to subscribing devices. The network 206 may be used to communicate order data to the order server 224 and the fill server 226. The network 206 may also be used to communicate order data from the order server 224 to the exchange 230.

The exchange 230, which may be similar to the exchange 130 of FIG. 1, includes an order book 232 and a matching engine 234. The exchange 230 may include additional, different, or fewer components. The order book 232 is a database that includes data relating to unmatched trade orders that have been submitted to the exchange 230. For example, the order book 232 may include data relating to a market for a tradeable object, such as the inside market, market depth at various price levels, the last traded price, and the last traded quantity. The matching engine 234 may match contra-side bids and offers pending in the order book 232. For example, the matching engine 234 may execute one or more matching algorithms that match contra-side bids and offers. A sell order is contra-side to a buy order. Similarly, a buy order is contra-side to a sell order. A matching algorithm may match contra-side bids and offers at the same price, for example. In certain embodiments, the additional exchanges 230a-230n may each include order books and matching engines (individually identified as the order book 232a-232n and the matching engine 234a-234n, which may be similar to the order book 232 and the matching engine 234, respectively). Different exchanges may use different data structures and algorithms for tracking data related to orders and matching orders.

In operation, the exchange 230 may provide price data from the order book 232 to the price server 222 and order data and/or fill data from the matching engine 234 to the order server 224 and/or the fill server 226. Servers 222, 224, 226 may process and communicate this data to the trading device 210. The trading device 210, for example, using a trading application, may process this data. For example, the data may be displayed to a user. In another example, the data may be utilized in a trading algorithm to determine whether a trade order should be submitted to the exchange 230. The trading device 210 may prepare and send an order message to the exchange 230.

In certain embodiments, the gateway 220 is part of the trading device 210. For example, the components of the gateway 220 may be part of the same computing platform as the trading device 210. As another example, the functionality of the gateway 220 may be performed by components of the trading device 210. In certain embodiments, the gateway 220 is not present. Such an arrangement may occur when the trading device 210 does not need to utilize the gateway 220 to communicate with the exchange 230, such as if the trading device 210 has been adapted to communicate directly with the exchange 230.

### IV. Example Computing Device

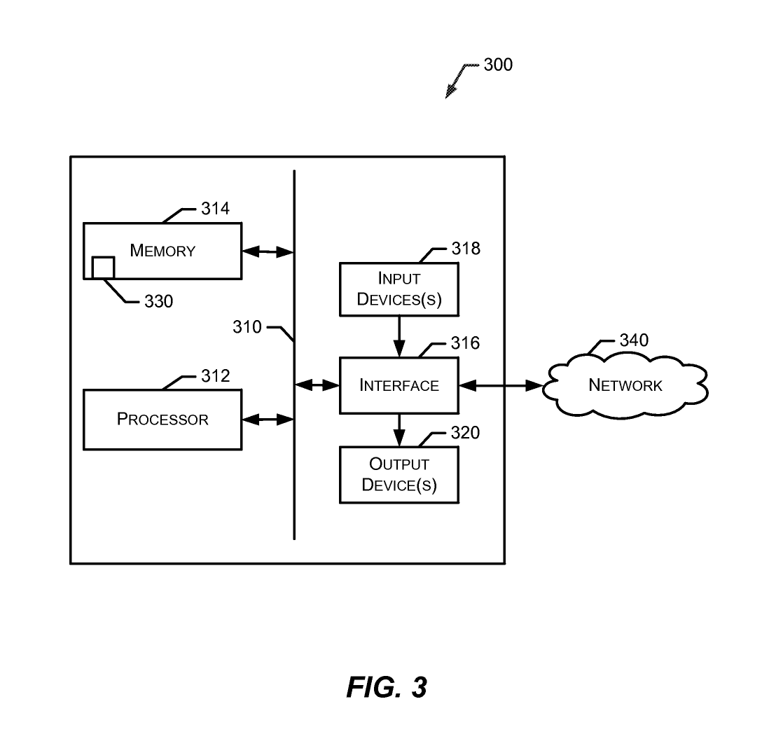

FIG. 3 illustrates a block diagram of an example computing device 300 which may be used to implement the disclosed embodiments. The trading device 110 of FIG. 1 may include one or more computing devices 300, for example. The gateway 120 of FIG. 1 may include one or more computing devices 300, for example. The exchange 130 of FIG. 1 may include one or more computing devices 300, for example.

The computing device 300 includes a communication network 310, a processor 312, a memory 314, an interface 316, an input device 318, and an output device 320. The computing device 300 may include additional, different, or fewer components. For example, multiple communication networks, multiple processors, multiple memory, multiple interfaces, multiple input devices, multiple output devices, or any combination thereof, may be provided. As another example, the computing device 300 may not include an input device 318 or output device 320.

As shown in FIG. 3, the computing device 300 may include a processor 312 coupled to a communication network 310. The communication network 310 may include a communication bus, channel, electrical or optical network, circuit, switch, fabric, or other mechanism for communicating data between components in the computing device 300. The communication network 310 may be communicatively coupled with and transfer data between any of the components of the computing device 300.

The processor 312 may be any suitable processor, processing unit, or microprocessor. The processor 312 may include one or more general processors, digital signal processors, application specific integrated circuits, field programmable gate arrays, analog circuits, digital circuits, programmed processors, and/or combinations thereof, for example. The processor 312 may be a single device or a combination of devices, such as one or more devices associated with a network or distributed processing. Any processing strategy may be used, such as multi-processing, multi-tasking, parallel processing, and/or remote processing. Processing may be local or remote and may be moved from one processor to another processor. In certain embodiments, the computing device 300 is a multi-processor system and, thus, may include one or more additional processors which are communicatively coupled to the communication network 310.

The processor 312 may be operable to execute logic and other computer readable instructions encoded in one or more tangible media, such as the memory 314. As used herein, logic encoded in one or more tangible media includes instructions which may be executable by the processor 312 or a different processor. The logic may be stored as part of software, hardware, integrated circuits, firmware, and/or micro-code, for example. The logic may be received from an external communication device via a communication network such as the network 340. The processor 312 may execute the logic to perform the functions, acts, or tasks illustrated in the figures or described herein.

The memory 314 may be one or more tangible media, such as computer readable storage media, for example. Computer readable storage media may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable medium and to exclude propagating signals. The memory 314 may include any desired type of mass storage device including hard disk drives, optical media, magnetic tape or disk, etc.

The memory 314 may include one or more memory devices. For example, the memory 314 may include local memory, a mass storage device, volatile memory, non-volatile memory, or a combination thereof. The memory 314 may be adjacent to, part of, programmed with, networked with, and/or remote from processor 312, so the data stored in the memory 314 may be retrieved and processed by the processor 312, for example. The memory 314 may store instructions which are executable by the processor 312. The instructions may be executed to perform one or more of the acts or functions described herein or shown in the figures.

The memory 314 may store a trading application 330. In certain embodiments, the trading application 330 may be accessed from or stored in different locations. The processor 312 may access the trading application 330 stored in the memory 314 and execute computer-readable instructions included in the trading application 330.

In certain embodiments, during an installation process, the trading application may be transferred from the input device 318 and/or the network 340 to the memory 314. When the computing device 300 is running or preparing to run the trading application 330, the processor 312 may retrieve the instructions from the memory 314 via the communication network 310.

### V. Example Location- and/or Presence-Based Risk Mitigation Systems and Methods

Certain examples provide systems and methods to mitigate trading risk when it is detected or determined that a trader is away from their trading station when a risk event occurs. For example, the disclosed systems and methods alert a risk manager if the trader is determined to be away from their trading station when a risk event occurs.

Risk events may include, for example, a rapid decrease in profit and loss (P&L), a sustained increase in a number of position(s), and a breach of a threshold. Other example risk events may include market events such as a release of employment or manufacturing data, and other corporate and government metrics.

Systems and methods track and/or otherwise identify a location and/or presence of a trader with respect to an active trading device (e.g., a trader's workstation, smart phone, tablet, etc.). In certain examples, systems and other hardware (e.g., one or more detection devices) to determine and detect a trader's location may include a mesh of devices cooperating to provide location. For example, hardware such as a camera at the trader's workstation, accelerometer and/or global positioning system (GPS) built into the trader's smartphone, camera and/or microphone on a trader's smartphone, digital images captured via a building's monitoring system, and/or social media feeds such as Twitter™ or Facebook™ may cooperate to provide location information.

In certain examples, location information may be gathered in a ‘passive’ manner by inferring present location from secondary observations such as frequent acceleration changes detected at the trader's smartphone indicating movement within, for example, an automobile, train, or other conveyance. Additional passive information may be gathered from social media sources identifying the trader's presence via a user submission, automatic hardware/software handshake, etc.

Alternatively or in addition to, location information can be provided actively by a geo-fencing process, a daemon executing in the background of one or more devices, a dedicated and active software application, and/or other process executing on one or more devices in contact with the trader. Each active daemon, application, and/or other process can be configured to at least communicate location information describing a current or last known position of the trader. The communicated location information may be directed to a central depository such as a cloud-based location aggregator and manager. In another example, the location information may be sent directly (e.g., point to point) to a risk manager/risk administrator overseeing the trader's trading activities.

Upon detection of a risk event and a determination that the trader's location may be of issue, the disclosed systems and methods alert a risk manager. An alert may include one or more of a desktop pop-up, screen notification, message log, text message, and/or other attention attracting mechanisms. The risk manager may further be presented with one or more possible risk mitigation strategies that include the alerts and/or notifications of the detected risk event. Strategies can further include trade(s) necessary to currently “get flat”, delete current working order, and/or kill an executing trading algorithm/strategy, for example.

### A. Example Risk Administrator Device

In certain examples, a risk mitigation strategy and/or other trader oversight involves a risk manager or risk administrator. For example, the risk administrator may be a manager, administrator, experienced trader, an exchange representative, or government official. In some examples, the risk administrator refers to a plurality of reviewing individuals and/or devices that form reviewing groups or teams.

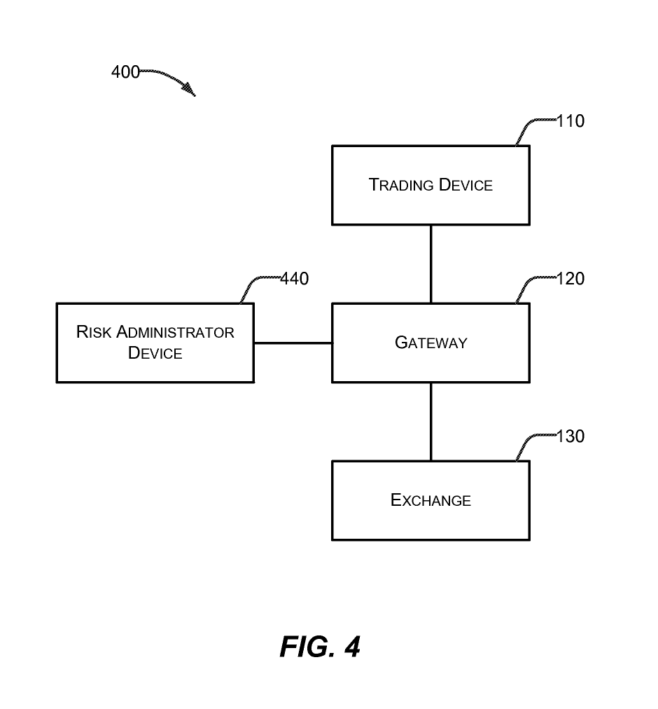

Referring to the example shown in FIG. 4, the system 400 includes a risk administrator device 440 in communication with trading device 110, gateway 120, and exchange 130. The risk administrator device 440 may enable a risk administrator to review and/or approve a trade and/or trading algorithm, for example. The risk administrator device 440 may be authorized to review and/or approve a trade and/or trading algorithm independent of a human risk manager. For example, the risk administrator device 440 may be a computing device configured to, among other things, execute an authorization application that enables a human risk manager to review and/or approve a trading algorithm.

The risk administrator device 440 is in communication with the trading device 110, the gateway 120, and/or the exchange 130. In some examples, the risk administrator device 440 need not be in communication with the gateway 120 and/or the exchange 130 and, instead, may be in communication only with the trading device 110. The example risk administrator device 440 may be configured to cooperate with one or more trading applications (for example, X_TRADER®) and/or trading algorithm design tools (for example, ADL®). In some examples, the trading application(s) and/or trading algorithm design tool(s) may be configured to function as the authorization application to facilitate review and/or approval/disapproval of a trading algorithm by a human risk manager.

In certain examples, the example risk administrator device 440 can normalize or otherwise rank a plurality of traders with respect to a risk threshold or other standard of risk. Based on an evaluation of relative risk in comparison to a threshold or standard, the risk administrator device 440 can assign a unit value to a trader representing a conversion of the trader's P&L amount to one or more units (and/or partial units). The unit value can be graphically depicted via a risk interface presented by the risk manager, for example.

In certain examples, the risk administrator device 440 can monitor and/or otherwise receive update(s) regarding a monitored trader based on location and/or presence of the trader with respect to the trading device 110. Upon detection of a risk event and a determination that the trader may not be located near a trading device 110 to be able to take action, the risk administrator device 440 may determine a risk mitigation strategy that alerts a risk manager regarding the trader's actual or potential unavailability. The risk mitigation strategy may include one or more of a desktop pop-up, screen notification, message log, text message, and/or other attention attracting mechanism triggered by the risk administrator device 440. The risk mitigation strategy presented by the risk administrator device 440 may further present the risk manager with one or more possible risk mitigation actions. Risk mitigation actions defined by the risk mitigation strategy can include trade(s) to be made to “get flat” from a current position, deleting current working order, submission of a hedge order, and/or killing an executing trading algorithm/strategy, for example. In certain embodiments, the risk mitigation strategy may operate autonomously and execute one or more pre-defined risk mitigation actions upon detection of a risk event. For example, the risk mitigation strategy may be an algorithm defined by an automated trading tool such as ADL®, and may subscribe or otherwise monitor market data to detect the occurrence of a risk event.

### B. Example Methods of Mitigating Communication Risk

Example methods to mitigate risk based on trader presence or absence in an electronic trading system are disclosed and described herein.

A trader can be associated with multiple devices and applications provided via a desktop and/or mobile trading device configured to make trades and/or otherwise interact with a market and its exchange, for example. Certain examples disclosed herein monitor a presence of the trader with respect to his or her trading device. For example, the trading device may be a desktop-based computer device that can measure a strength of a signal received by the trading device from a mobile device, an office ID or other tracking device held or worn by the trader.

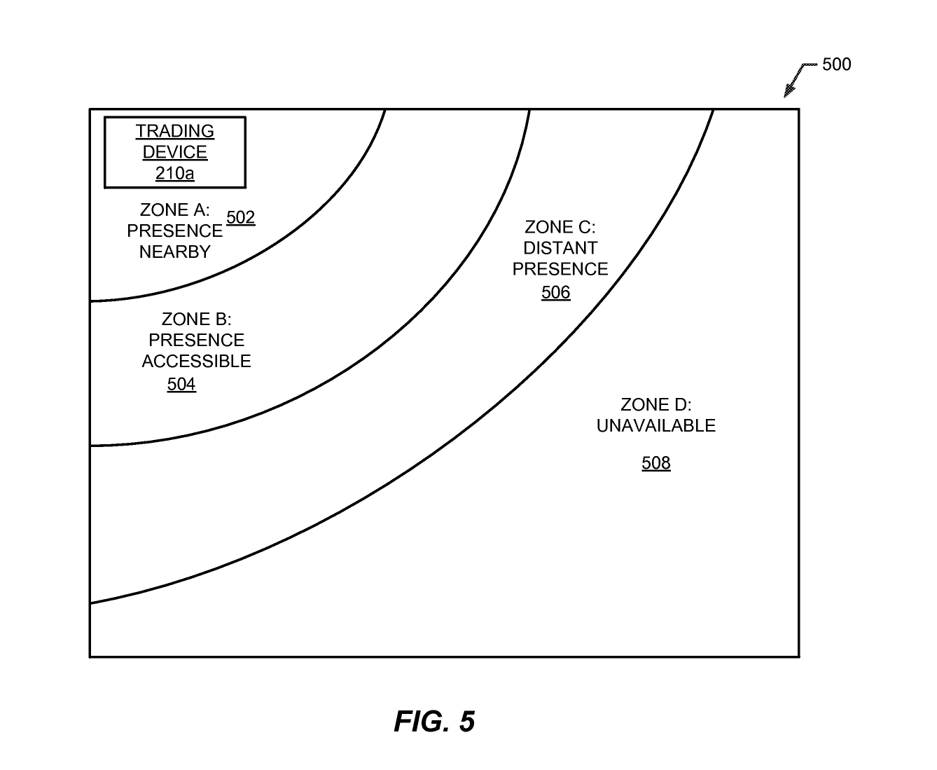

Examples may also include determining a presence state of the trader in relation to the trader device. For example, as shown in FIG. 5, a trader's environment may be divided into a plurality of zones: Zone A 502, in which the trader's presence is nearby; Zone B 504, in which the trader's presence is accessible; Zone C 506, in which the trader's presence is distant; and Zone D 508, in which the trader is unavailable. A proximity sensor on a trading device and/or a locator on the trader can provide feedback to determine how far the trader is from his or her trading device 210. Depending upon the zone 502-508 in which the trader is located, certain functionality is provided to the trader and/or certain risk mitigation actions are taken by a risk administrator and/or automated risk management system, for example.

In some examples, a presence risk threshold is set (e.g., by a user, automatically by a trading application, etc.). In some examples, the presence risk threshold is a predetermined state of a trader's presence at or near a trading device 210 at which a given amount of risk exists that the trader will be unable, due to location or lack of presence near the trading device 210, to respond to a market condition at the trading device 210. If the presence state falls below the presence risk threshold, a risk mitigation action may be initiated at the trading device 210 as part of an overall risk mitigation strategy. The risk mitigation action is any action mitigating or performed to mitigate a risk of a market position and/or working order due to an unavailability of the trader at or near the trading device 210 to act on a market risk event.

Example risk mitigation actions include generating an alert or warning by the mobile device and providing the alert or warning to a user to indicate that the mobile trading device may not be capable of closing an open market position; executing instructions stored at the gateway to enable the user to get flat in the market position; and uploading or communicating instructions stored on the mobile trading device to the gateway for execution in the event that communications are interrupted. The above-noted risk mitigation actions are merely examples and, thus, other risk mitigation actions may be performed without departing from the scope of this disclosure. Multiple risk mitigation actions may be defined as part of the risk mitigation strategy.

Certain examples disclosed herein determine a presence state of the trader with associated with the trading device 210 based on a location of the trader with respect to the trading device 210. A qualitative and/or quantitative measurement, value, and/or status of a trader presence condition is a state of the trader's location or presence (“a presence state”). The presence state of a particular trader with respect to a trading device 210 reflects an ability of the trader to communicate with the trading device 210. If the presence state reaches or falls below a minimum threshold state, the trader may not be able to interact with the trading device 210 and affect the market. If a market position is open when the presence state is at or below the minimum threshold state and a market risk event occurs, the market position may not be able to be closed via the trading device 210. Thus, a decrease in the trader's presence state may present and/or increase a risk of a market position not closing due to an interruption in communication between the trading device 210 and the trader. A failure to close a market position can, for example, result in a loss of money, a lost opportunity, and an incorrect trade.

The presence state of a particular trader can be stored over a period of hours, days, weeks and any other desired periods in order to identify trends and patterns in presence states. Identified trends and patterns in presence states may be utilized to create a profile which may be used and/or referenced prior to initiation of a risk mitigation action defined as part of a risk administration strategy.

To mitigate the risk, a risk mitigation strategy including one or more risk mitigation actions is initiated if the presence state falls below a presence risk threshold (e.g., below a threshold state). In some examples, the presence risk threshold is a predetermined presence state at which a given amount of risk is present that the communication between the trading device 210 and the trader will be interrupted.

The risk mitigation action is any action mitigating or performed via the trading device 210 and/or the gateway 220 to mitigate a risk of a market position not closing due to an unavailability of the trader to interact with the trading device 210. In some examples, the risk mitigation action includes executing instructions stored at the gateway 220 to enable a user to get flat in a market position (e.g., communicate with the exchange 230 to perform a transaction, reject a trade message, etc. to prevent the user from having a surplus or deficit of a commodity), providing a message (e.g., an alert, a warning, a prompt) to the user, and/or performing any other risk mitigation action. In some examples, the risk mitigation action includes preventing a position from being opened via the trading device 210.

For example, the presence and/or location of the trader with respect to the trading device 210 and the gateway 220 may be monitored by measuring or detecting trader presence using one or more sensors (e.g., using a proximity sensor). If the trading device 210 detects a presence having a likelihood of responsiveness at or below the given percentage, a risk mitigation action stored at the trading device 210 and/or gateway 220 as part of the risk mitigation action is initiated. For example, the risk mitigation action defined as part of the risk mitigation strategy may include providing an alert indicating that a market position may not be capable of being closing via the trading device 210, and executing instructions stored at the gateway 220 to enable a user to get flat in a market position. The risk mitigation action selected for execution may be continuously, or substantially continuously, updated to reflect trader presence by polling or otherwise communicating with one or more detection devices to determine the presence state associated with the trader.

Returning to the example area 500 illustrated in FIG. 5 depicting an example in which the trading device 210 may be located. In the illustrated example, the area 500 includes a plurality of zones 502, 504, 506, 508, 510. Each of the example zones 502, 504, 506, 508, 510 defines a geographic region as a function of a trader presence or availability evaluated with respect to the trading device 210. In the illustrated example, the trader presence is a relative location or degree of presence of the trader with respect to the location of the trading device 210. For example, Zone A 502 is associated with a direct or nearby trader presence; Zone B 504 is associated with an accessible trader presence; Zone C 506 is associated with distant trader presence; and Zone D 510 is associated with an unavailable trader presence, etc. In other examples, the zones 502, 504, 506, 508, 510 are associated with other states and/or communication conditions such as the signal-to-noise ratio, and the type of network available.

In the illustrated example of FIG. 5, a presence state is determined based on a location of the trading device 210. In some examples, the trading device 210 determines its location via one or more detection devices such as a GPS tracking device and/or with respect to another device. If the trading device 210 is located in one of the zones 502, 504, 506, 508, 510, the trading device 210 is associated with a presence state (e.g., a level of presence) of the zone 502, 504, 506, 508, 510 in which the trading device 210 is located. For example, if the trading device 210 determines that it is located in Zone D 508, the trading device 210 is associated with the presence state that is associated with Zone D 508: distant presence. If a distant presence is at or below the presence risk threshold, a risk mitigation action is initiated. In some examples, if the trading device 210 is within a predetermined distance (e.g., twenty feet) in or near a zone associated with a presence state at or below the presence risk threshold, the risk mitigation action is initiated. For example, a message (e.g., an alert, a warning, etc.) may be provided via the trading device 210 indicating that the trading device 210 is located near the zone associated with the presence state at or below the presence risk threshold.

In the illustrated example, a map is generated (e.g., the zones 502, 504, 506, 508, 510 are determined and/or associated with a degree of trader presence) based on one or more accumulated presence states and trading device locations communicated by a plurality of trading devices 210 (e.g., mobile trading devices) including the trading device 210 and other trading devices. For example, a trading device 210 and/or associated system monitors a location/presence state of a trader and communicates the presence state and/or location to a central location such as, for example, the gateway 220. Based on the presence states and the locations, a host monitors and assesses reaction risk based on trader location, presence, etc.

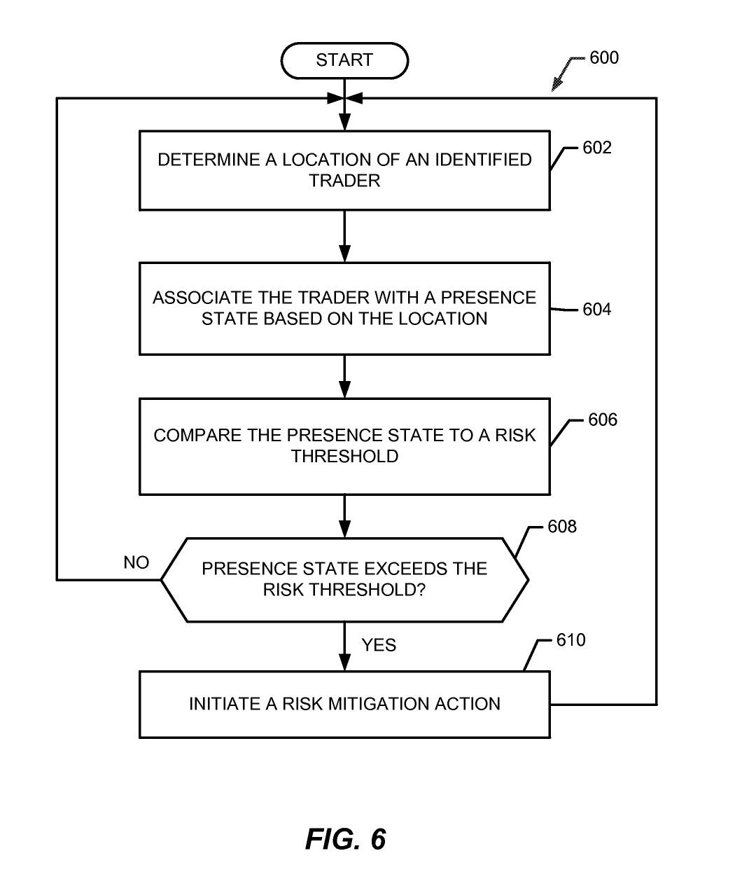

FIG. 6 illustrates a flow diagram of an example method 600 to mitigate risk in an electronic trading system. The example method 600 may be performed by any trading device (e.g., the trading device 110 of FIG. 1, the trading device 210 of FIG. 2, etc.) and/or gateway (e.g., the gateway 120 of FIG. 1, the gateway 220 of FIG. 2, the gateway 220n of FIG. 2, etc.). The example method 600 executes with respect to an identified user (e.g., an identified trader). At block 602, a location of the identified trader is determined. In some examples, the trader has a detection device such as a GPS tracking device, infrared tracking device, near field communication device, camera, microphone, etc., built into the trader's smartphone. The location of the trader can be determined via the tracking device.

At block 604, the trader is associated with a presence state based on the determined location. For example, based on the location determined at block 602, trader location may be associated with an area or zone such as presence nearby 502, presence accessible 504, distant presence 506, or unavailable 508 as shown in the example of FIG. 5. A presence state of available, accessible, distant, or unavailable may be associated with the trader based on the determined location zone 502-508, for example.

At block 606, the presence state is compared to a risk threshold. For example, a distance of the trader from an available trading device is compared to a likelihood of risk associated with the trader. For example, if the trader is a high-risk trader, then the trader may have a lower risk threshold (e.g., a lower tolerance for risk) than a low-risk trader. Similarly, an experienced trader may have a higher risk threshold (e.g., a higher tolerance for risk) than an inexperienced trader. A trader executing complicated trading strategies may have a lower risk threshold than a trader executing basic trades, for example. The risk threshold relates to the trader's presence state, for example, by indicating that how close the trader should be to a trading device when the trader is associated with a certain risk level, trade complexity, etc., and/or when market activity (e.g., a trading strategy being executed by and/or for the trader) has a certain level of risk or volatility.

At block 608, if the presence state exceeds the risk threshold, a risk mitigation action defined as part of a risk mitigation strategy is initiated (at block 610). In some examples, the selected risk mitigation action is initiated at the gateway. For example, instructions stored at the gateway may be executed to enable a user to get flat in a market position. In other examples, the risk mitigation action is initiated at the trading device. For example, the trading device may generate and/or display an alert indicating that the presence state fell below the risk threshold, and/or a trading application stored on the trading device may prevent a market position from being opened via the trading device. In some examples, instructions stored on the trading device are uploaded or communicated to the gateway for execution in the event that the trader is unable to reach the trading device. In some examples, a risk administrator can be alerted to act on behalf of the trader (e.g., to make a trade to go flat, to send a message to the trader, to engage an alternate trader, etc.) In some examples, the risk mitigation action involves preventing the trader and/or preventing the trading device from opening a further market position until the trader's presence state no longer exceeds the risk threshold.

The example method 600 then returns to block 602. If the presence state has not fallen below the risk threshold as determined at block 608, then the example method 600 also returns to block 602.

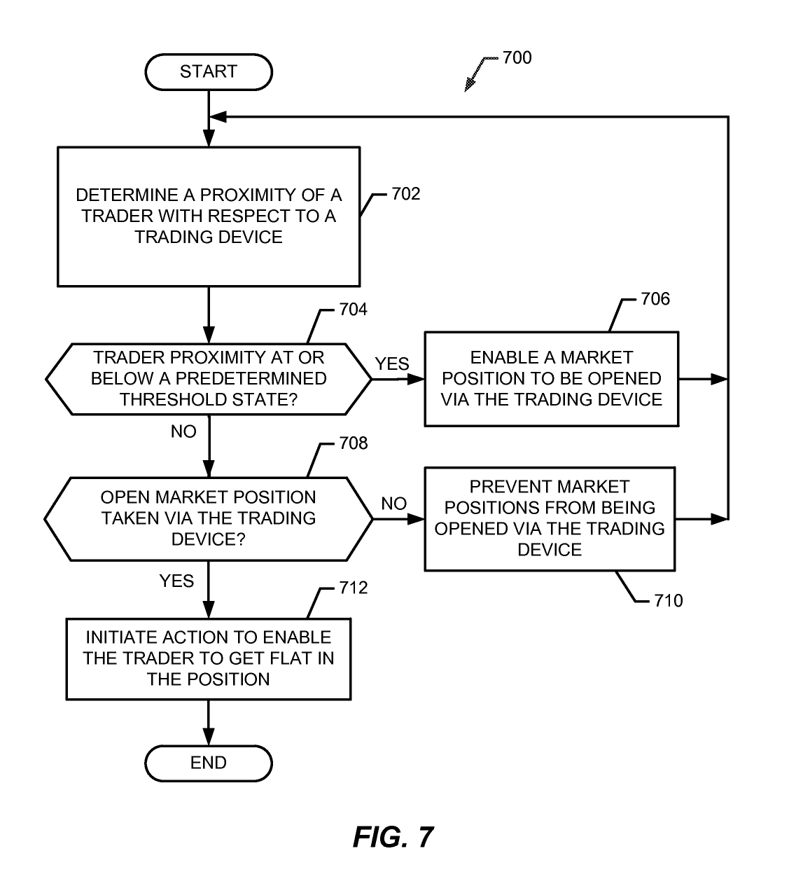

FIG. 7 illustrates a flow diagram of an example risk mitigation strategy 700. At block 702, a trader's proximity to a trading device is determined relative to, for example, a trading device 210 or other fixed and/or known location. At block 704, the proximity is evaluated against a predetermined threshold state. For example, the trader's closeness to his or her trading device is evaluated against an acceptable distance from the trading device. For example, an acceptable distance may be no effective distance at all (e.g., sitting at the workstation). In some examples, the trader should not only be sitting at the workstation but also interacting with the workstation (e.g., as evidenced by keystroke, cursor movement, camera, etc.). In some examples, the trader's close proximity (e.g., based on camera, GPS, etc.) to the trading device may be an acceptable proximity.

At block 706, if the trader proximity is within an acceptable limit, a market position can be opened via the trading device and control returns to block 702. However, at block 708, if trader proximity is not within an acceptable limit, trader activity is analyzed to determine whether the trader has an open market position. At block 710, if the trader does not have any open market position, then market positions are prevented from being opened via the trading device (e.g., until the trader proximity is back within an acceptable limit) and control returns to block 702. At block 712, if the trader does have an open market position, action is initiated to enable the trader to get flat in the market position.

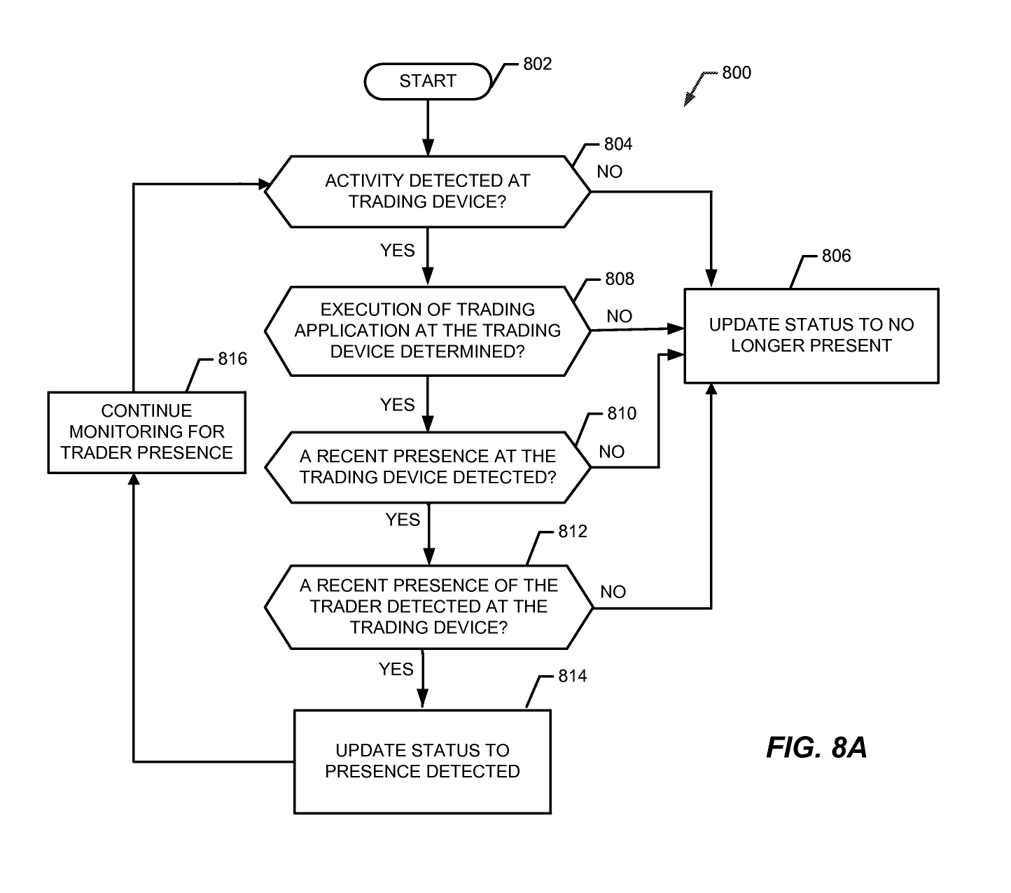

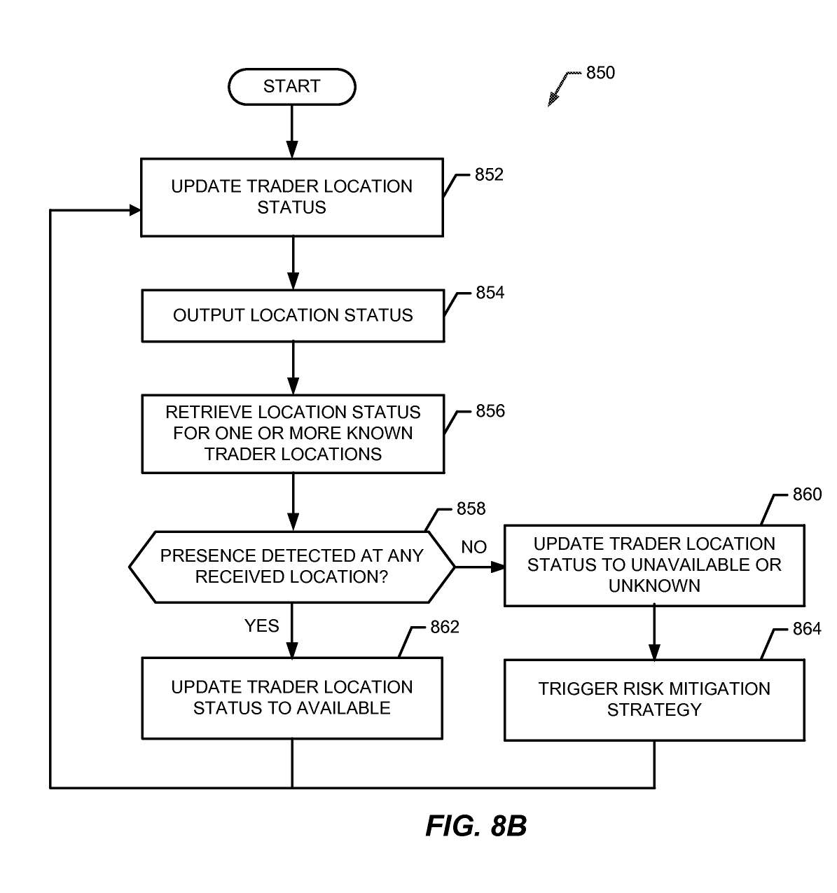

FIG. 8A illustrates a flow diagram of an example method 800 for user presence detection and status notification. At block 802, monitoring of trading and trader activity begins. For example, a monitoring routine in a trading application and/or a separate application or process monitoring activity in the background (e.g., a background application) on a trading device.

At block 804, activity at the trading device is detected to determine whether a trading device is active. For example, the background application monitors the trading device to detect trades, market updates, and/or other update or interaction with the trading device. In another example, the background application can determine or infer activity on the trading device based on the movement and/or location of the device itself. If the background application detects such activity, then the trading device can be inferred to be active. If the trading device is determined or inferred to be inactive, then, at block 806, a status indication is set to “No Longer Present” or other similar status indicator of trader unavailability.

If, however, the trading device is active, then, at block 808, execution of a trading application on the trading device is determined. For example, the background application/process monitors the trading device to determine whether a trading application is running on the trading device (e.g., by detecting trades, market updates, and/or other update or interaction with the trading device). If the background application detects such activity, then the trading application is running. If the trading application is not running on the trading device, then, at block 806, the status indicator is set to be “No Longer Present” or other similar status indicator of trader unavailability.

If the trading application is determined to be running on the trading device, then, at block 810, a recent presence at the trading device is detected. For example, a home automation and/or security system operating with respect to a trader working from home and/or in an office can detect motion and infer a presence at the location. For example, a trader's home office, a trading company floor, etc., can have one or more smart devices such as a Nest Learning Thermostat®, Nest Protect®, etc., with a motion sensor, infrared camera, and/or other sensing devices, to detect motion in an area, such as an area around a trading device. If no presence is detected, then, at block 806, the status indicator is set to “No Longer Present” or other similar status indicator of trader unavailability.

If, however, a presence is detected, then, at block 812, a recent user presence at the trading device is detected. For example, a camera (e.g., webcam, etc.) can detect a particular user/trader presence at or near the trading device. Facial recognition and/or other computer vision technique can be used to identify the trader whose presence has been detected. Thus, at block 810, a presence is detected and, at block 812, a particular trader associated with that presence is detected. If the presence of the trader is not detected at or near his her or trading device, then, at block 806, the status indicators is updated to show the trader is “No Longer Present” or other similar status indicator of trader unavailability.

If the trader is identified as present at or near the trading device, then, at block 814, the status indicator is updated to show that the trader's presence is detected. This presence indication can be passed along to an external system (e.g., a trading strategy or algorithm design server, etc.) via a network (e.g., the cloud, the Internet, local area network, wide area, network, virtual private network, etc.). If the trader's presence is detected, then trading activity can continue at the trading device with the trader, for example. If the trader's presence is not detected, then trading activity can be reduced, limited, halted (e.g., “get flat”), etc., and/or a risk administrator can be alerted to the trader's unavailability, for example. At block 816, monitoring continues (e.g., by the background application/process) to watch for trader presence and/or absence in conjunction with trading activity and associated trading risk, for example.

FIG. 8B illustrates a flow diagram of an example method 850 for user presence detection and status notification upon determination of trader status with respect to the trading device. As shown in the example of FIG. 8B, a status update (e.g., No Longer Present (e.g., block 806 from FIG. 8A) or Presence Detected (e.g., block 814 from FIG. 8B)) is provided, and, at block 852, a location status for the trader is updated. For example, the location status is updated to reflect a No Longer Present location status or a Presence Detected location status based on. At block 854, location status information is coordinated and output (e.g., broadcast to multiple devices, unicast to a trader's trading device, multicast to several devices, etc.).

At block 856, a trader location/presence status is retrieved for one or more known locations. For example, periodically (e.g., as dictated by a timer set to periodically query and obtain or update trader location/presence information from one or more trading devices), trading devices are queried for location trader status information.

At block 858, location status responses are reviewed to determine whether presence has been detected at any location for which a status response has been received. If no presence has been detected, then, at block 860, a global location status is set to unknown or unavailable, for example. That global location status can be output at block 854, for example. If a trader presence has been detected, then, at block 862, a global location status is updated to be available or “Presence Detected”, for example. In certain examples, normal trading operation proceeds if the trader is available.

At block 864, if the global location status is set to unknown or unavailable, a risk mitigation strategy is triggered. The risk mitigation strategy includes one or more risk mitigation actions. For example, a trading strategy (e.g., algorithm) server and/or a risk administrator can be notified of trader location/presence status via broadcast, multicast, unicast, etc., at block 854, and a risk mitigation strategy can be triggered. For example, if a trader associated with a trading algorithm for execution is not available, then the algorithm server may decide not to execute the rest of the trader's algorithm. The risk administrator may also consider the availability or unavailability of the trader and execute a risk mitigation strategy in allowing or not allowing execution of a trading strategy algorithm. Risk mitigation action(s) forming a risk mitigation strategy can include automatically flattening a position held by the trader, moving a working order, deleting a working order, triggering submission of a trading strategy algorithm, and assigning an order to a second trader, etc.

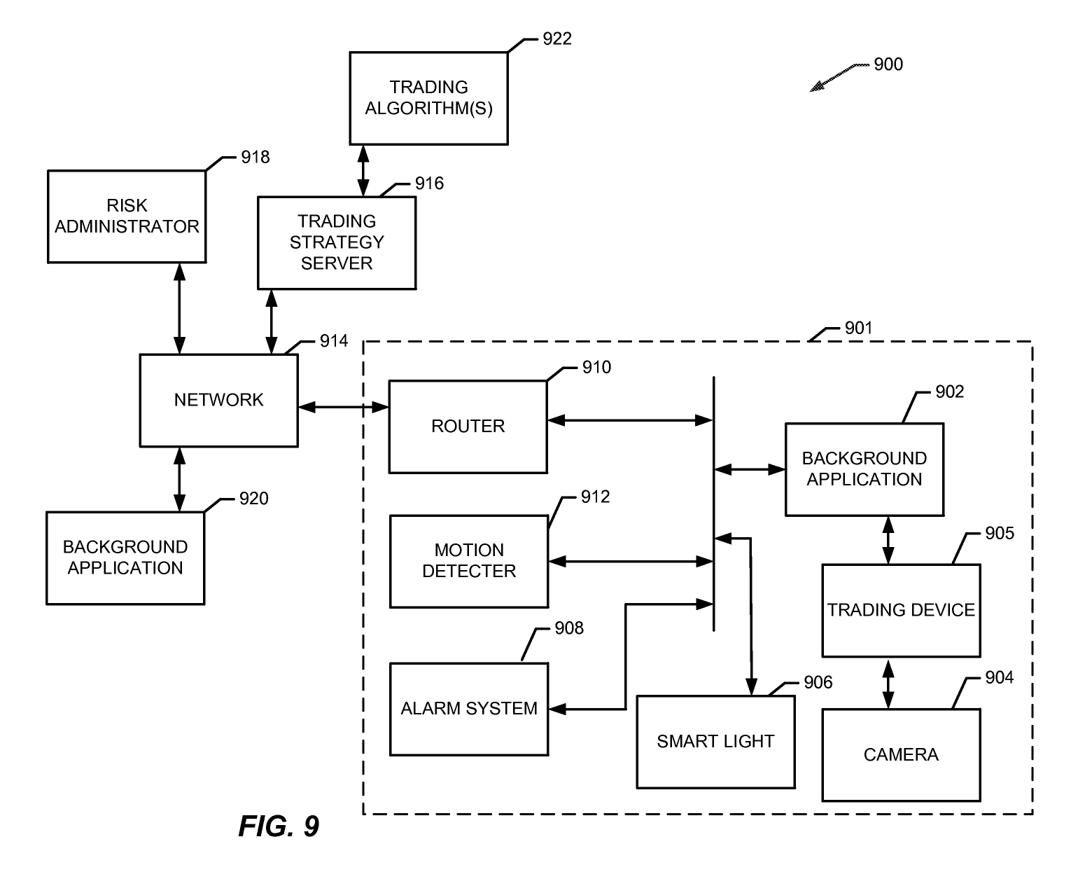

FIG. 9 illustrates an example system 900 including a suite of presence detectors interacting with a monitoring application to track and provide a status update regarding a trader's location with respect to a trading device. The example system 900 includes a monitoring application 902 monitoring operation of a trading device 905 and/or a trader using the trading device 905 at a location 901, such as a trading facility, home, office, etc. The monitoring application 902 can operate in the background with respect to the trading device 905, for example, and monitors application(s) executing on the trading device 905 as well as operations in the surrounding area.

The monitoring application 902 interacts with one or more external sensors at the location 901 as well as the trading device 905. For example, external sensors may include a camera 904 (e.g., a camera connected to the trading device 905 to monitor for user presence at or near the trading device 905), a smart light (e.g., a network controllable light with sensor) 906, an alarm system 908, and/or a motion detector 912. As described above in connection with the example methods 600, 700, 800 and 850, the external sensors can, in turn, be used to determine whether anyone is at or near the trading device 905 and then determine if that entity is the trader of interest to operate a trading application on the trading device 905. Presence/location and/or other information can be routed via a router 910 across a network 914 to a trading strategy server 916, a risk manager 918, and/or any other suitable device or remote storage location.

An additional background application 920 may be used on a trader's mobile device to detect and/or track user presence outside of the location 901. The background application 920 can also communicate via the network 914 to transfer monitoring data for storage, processing, etc. The background application 920 can interact with the background application 902 over the network 914 to monitor one or more factors including distance, time since departure, network access, etc.

One or more risk mitigation strategies can be implemented based on trader presence and/or other trader status. For example, depending upon trader presence, one or more trading algorithms 922 may or may not be allowed to execute according to the algorithm server 916, risk administrator 918, and/or monitoring application 902. Depending upon trader presence, the risk administrator 918 may initiate a risk mitigation strategy including one or more risk mitigation actions to extract a trader from a risky market position (e.g., get “flat”) when the trader is not sitting at his or her trading device 905, for example.

In certain examples, the system 900 can include monitoring devices in a plurality of rooms or areas throughout a trading facility, and a map can be generated based on trader location(s) throughout the facility. In an area with multiple traders, each trader can be unique identified based on, for example, facial recognition, unique radio frequency identification (RFID) signature, etc., and a map can be created showing trader locations with respect to one or more available trading devices. Thus, the system knows who is available and how close they are to an available trading device when a risk event occurs.

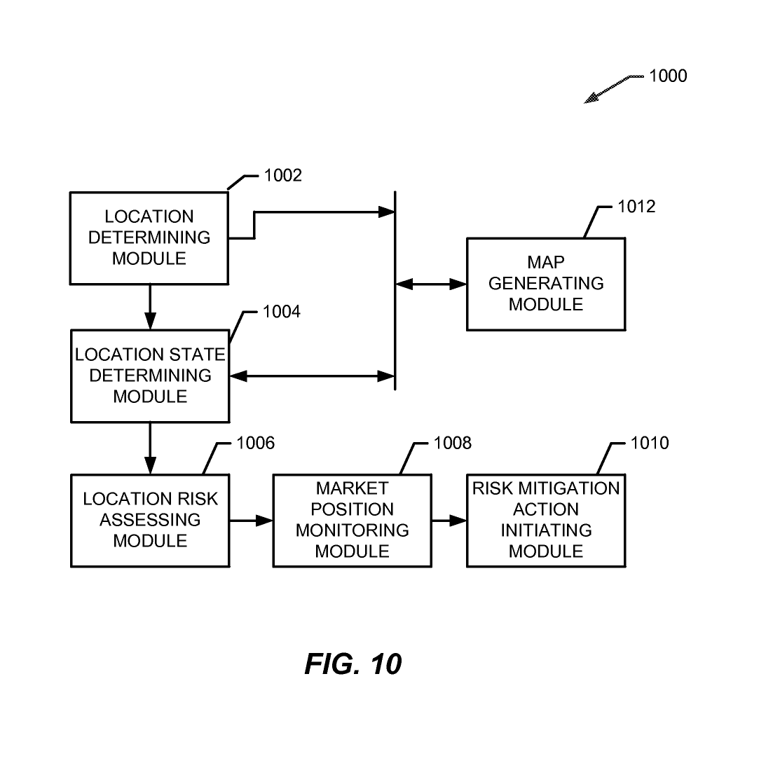

FIG. 10 is a block diagram of an example system 1000 that can implement and/or execute the example operations of FIGS. 5-9. In some examples, the system 1000 may be implemented as part of software (or an application) associated with the trading device 110 of FIGS. 1 and 3, the trading device 220 of FIG. 2, gateway 120 of FIG. 1, the gateway 220 of FIG. 2 and/or the gateway 220n of FIG. 2. In some examples, the system 1000 may be implemented as computer implemented code or instructions operable independent of software associated with the trading device 110, the trading device 220, the gateway 120, the gateway 220 and/or the gateway 220n. In some examples, the features and functionality of the system 800 may be implemented in hardware operable in connection with the trading device 110, the trading device 210, the gateway 120, the gateway 220 and/or the gateway 220n.

The example system 1000 of FIG. 10 includes a location determining module 1002 to determine a location of a trader. In some examples, the location determining module 1002 communicates with a map generating module 1012 to generate a visual “map” representation of trader location. The location determining module 1002 can determine and track trader location using RFID, GPS, NFC, infrared, computer vision, etc.

The example system 1000 of FIG. 10 includes a communication state determining module 1004. In some examples, the location state determining module 1004 determines a state of the trader's location by making, evaluating and/or determining a qualitative and/or quantitative measurement, value and/or status of trader location provided by the location determining module 1002. Some example location states include present, not present, nearby, accessible, distant, unavailable, etc. In some examples, the location state determining module 1004 determines the location state based on the location of the trader(s) determined via the location determining module 1002 and a map generated via a map generating module 1012.

The map generating module 1012 receives trader (and trading device) location information and location state from a plurality of trading devices and/or associated monitors, for example. In some examples, the location determining module 1002 communicates a location of a trader to the map generating module 1012, and the location state determining module 1004 communicates a location state to the map generating module 1012. The map generating module 1012 may associate the location state with the location. Based on the location and the location state, the map generating module 1012 generates and/or updates a map in which an area is associated with the location state (see, e.g., FIG. 5). In some examples, the map includes a plurality of areas associated with a plurality of location states. If a trader is located in one of the areas with respect to a trading device, the location state determining module 1004 associates the trader with the location state associated with the area.

The example system 1000 includes a location risk assessing module 1006 to determine if the location state exceeds a location risk threshold, which may be set by a user, a risk administrator, and/or a trading application, for example. In some examples, the location risk threshold corresponds to a minimum distance at which a trader can react to market activity including a market risk event at a trading device. The location risk threshold may vary based on trader experience, trading strategy, market activity, risk administrator discretion, etc.

In the illustrated example, a risk mitigation action initiating module 1010 of the example system 1000 of FIG. 10 initiates a risk mitigation action if the location state does not satisfy the location risk threshold. In some examples, a type of risk mitigation action performed is based on whether a market position taken via the trader's trading device is open. A market position monitoring module 1008 of the example system 1000 of FIG. 10 monitors market positions taken via the trading device. If a market position has been taken, the market position monitoring module 1008 determines if the market position is open. In some examples, if the market position is open, the risk mitigation action initiating module 1010 initiates one or more actions to enable the trader to get flat in the market position. In some examples, if the market position is not open, the risk mitigation action initiating module 1010 prevents any positions from being opened via the trading device (e.g., until the location state returns to a state that satisfies the location risk threshold). In some examples, additionally or alternatively, the risk mitigation action initiating module 1010 performs one or more other actions such as, for example, providing an alert or warning to the trader, to the risk administrator, to a log, etc.

In some examples, the risk mitigation action initiating module 1010 provides a notification to a risk administration and/or to the affected trader when the location state nears, reaches, and/or exceeds the location risk threshold. For example, a pop-up box, log message, etc., can be provided on the display of the risk administrator and/or trader's trading device.

In some examples, a notification is generated for the risk administrator when sensors detect that the trader has gotten up from his or her desk. The notification alerts the risk administrator that the trader may be absent or otherwise unavailable if a subsequent risk event occurs. In some examples, the trader's location/proximity status can be shared as a data feed among one or more users such as risk administrators, other traders (e.g., traders more senior to the trader in question, trading strategy algorithm generators, etc.). In some examples, a risk administration display includes a column or other additional data field showing location/availability of each monitored trader.

In some examples, a determination of whether or not the trader is at his or her desk or otherwise near an associated trading device can be used as a variable in a strategy or risk calculation determined by a risk management application. In some examples, rather than an available or unavailable location state, the trader's location may be associated with a finer granularity of location status information. For example, trader positioning information (e.g., GPS and/or other positioning information) can indicate that the trader is at or near his or her home, at his/her desk recently, near his/her trading device n minutes ago, active at trading device x within the last m minutes, traveling at high speed on an interstate highway, at a move theater, out of the country, etc., and such location information can factor into a trading strategy algorithm, risk management calculation, risk mitigation determination, etc. In some examples, risk mitigation can include automatically flattening a position, moving working order, deleting working orders, triggering submission of a trading strategy algorithm, blocking submission of a trading strategy algorithm, routing responsibility for orders to another trader (e.g., based on proximity, seniority, type of trade, etc.), etc.

Thus, for example, a trader can be monitored and, if the system determines that the trader has been unavailable or otherwise off-the-grid for a predefined period (e.g., no activity by the trader, a camera at the trader's workstation detects no trader, etc.), then a warning is sent to the risk administrator and the trader. If the trader has been unavailable for fifteen minutes, then a secondary indicator such as GPS is used to try to locate the trader. If the trader is still not locatable, then the risk administrator is notified to take and/or approve a next action to mitigate risk.

Thus, certain examples facilitate improved reliability and responsiveness in trading to handle risk events while accommodating trader location. Certain examples allow trader movement, breaks, and other activity while helping to ensure that a risk event does not pass unaddressed to the detriment the trader's market position. Certain examples facilitate trader back-up, redundancy, and/or other risk mitigation responsive to fast-paced market activity and an often hectic trading environment.

Detection and notification can be reactive (e.g., in response to a market event) and/or proactive (e.g., based on trader activity history, trader schedule information, type of market activity, trader seniority, trader risk, etc.). In some examples, a trader's calendar or schedule can be a factor along with location information in determining risk and risk mitigation.

Some of the described figures depict example block diagrams, systems, and/or flow diagrams representative of methods that may be used to implement all or part of certain embodiments. One or more of the components, elements, blocks, and/or functionality of the example block diagrams, systems, and/or flow diagrams may be implemented alone or in combination in hardware, firmware, discrete logic, as a set of computer readable instructions stored on a tangible computer readable medium, and/or any combinations thereof, for example.

The example block diagrams, systems, and/or flow diagrams may be implemented using any combination of application specific integrated circuit(s) (ASIC(s)), programmable logic device(s) (PLD(s)), field programmable logic device(s) (FPLD(s)), discrete logic, hardware, and/or firmware, for example. Also, some or all of the example methods may be implemented manually or in combination with the foregoing techniques, for example.

The example block diagrams, systems, and/or flow diagrams may be performed using one or more processors, controllers, and/or other processing devices, for example. For example, the examples may be implemented using coded instructions, for example, computer readable instructions, stored on a tangible computer readable medium. A tangible computer readable medium may include various types of volatile and non-volatile storage media, including, for example, random access memory (RAM), read-only memory (ROM), programmable read-only memory (PROM), electrically programmable read-only memory (EPROM), electrically erasable read-only memory (EEPROM), flash memory, a hard disk drive, optical media, magnetic tape, a file server, any other tangible data storage device, or any combination thereof. The tangible computer readable medium is non-transitory.

Further, although the example block diagrams, systems, and/or flow diagrams are described above with reference to the figures, other implementations may be employed. For example, the order of execution of the components, elements, blocks, and/or functionality may be changed and/or some of the components, elements, blocks, and/or functionality described may be changed, eliminated, sub-divided, or combined. Additionally, any or all of the components, elements, blocks, and/or functionality may be performed sequentially and/or in parallel by, for example, separate processing threads, processors, devices, discrete logic, and/or circuits.

While embodiments have been disclosed, various changes may be made and equivalents may be substituted. In addition, many modifications may be made to adapt a particular situation or material. Therefore, it is intended that the disclosed technology not be limited to the particular embodiments disclosed, but will include all embodiments falling within the scope of the appended claims.

What is claimed is:

1. A method comprising:
monitoring, using feedback from one or more detection devices, a location of a trader with respect to a trading device associated with the trader;
assigning, using a processor, a presence state to the trader based on the monitored location of the trader;
comparing, using the processor, the presence state of the trader with a risk threshold; and
triggering, using the processor, a risk mitigation strategy including a risk mitigation action, wherein the triggered risk mitigation action is determined based on the comparison between the presence state of the trader and the risk threshold.

2. The method of claim 1, further comprising:
determining an occurrence of a risk event, wherein the monitoring of the location of the trader occurs in response to the occurrence of the risk event.

3. The method of claim 1, wherein determining the location of the trader further comprises:
generating a first location information at a first detection device;
generating a second location information at a second detection device; and
determining the location of the trader based on the first location information and the second location information.

4. The method of claim 1, wherein the one or more detection devices include one or more of a camera, a radio frequency identifier, a global positioning system, and an infrared camera.

5. The method of claim 1, wherein the risk mitigation action includes actions selected from the group consisting of: providing a notification to a risk administrator, automatically flattening a position held by the trader, moving a working order, deleting a working order, triggering submission of a trading strategy algorithm, and assigning an order to a second trader.

6. The method of claim 5, further comprising providing a plurality of risk mitigation actions based on the trader and a current position held by the trader.

7. The method of claim 1, wherein the notification comprises a message sent to an application of the risk administrator.

8. The method of claim 1, further comprising modifying a trading strategy algorithm based on the presence state of the trader.

9. The method of claim 1, wherein assigning the presence state is further based on an experience of the trader.

10. A computer-readable storage medium including computer program instructions which, when executed by a processor, perform a method comprising:
monitoring, using feedback from one or more detection devices, a location of a trader with respect to a trading device associated with the trader;
assigning, using the processor, a presence state to the trader based on the monitored location of the trader;
comparing, using the processor, the presence state of the trader with a risk threshold; and
triggering, using the processor, a risk mitigation strategy including a risk mitigation action, wherein the triggered risk mitigation action is determined based on the comparison between the presence state of the trader and the risk threshold.

11. The computer-readable storage medium of claim 10, wherein the method further comprises determining an occurrence of a risk event, wherein the monitoring of the location of the trader occurs in response to the occurrence of the risk event.

12. The computer-readable storage medium of claim 10, wherein determining the location of the trader further comprises:
generating a first location information at a first detection device;
generating a second location information at a second detection device; and
determining the location of the trader based on the first location information and the second location information.

13. The computer-readable storage medium of claim 10, wherein the one or more detection devices include one or more of a camera, a radio frequency identifier, a global positioning system, and an infrared camera.

14. The computer-readable storage medium of claim 10, wherein the risk mitigation action includes actions selected from the group consisting of: providing a notification to a risk administrator, automatically flattening a position held by the trader, moving a working order, deleting a working order, triggering submission of a trading strategy algorithm, and assigning an order to a second trader.

15. The computer-readable storage medium of claim 14, wherein the method further comprises providing a plurality of risk mitigation actions based on the trader and a current position held by the trader.

16. The computer-readable storage medium of claim 10, wherein the method further comprises modifying a trading strategy algorithm based on the presence state of the trader.

17. The computer-readable storage medium of claim 10, wherein assigning the presence state is further based on an experience of the trader.

18. A system comprising:
a trading device configured to execute a trade order, the trading device in communication with one or more detection devices to provide a location of a trader, the trading device including a processor and a memory to execute instructions stored thereon to:
monitor, using feedback from the one or more detection devices, a location of a trader with respect to a trading device associated with the trader;
assign, using the processor, a presence state to the trader based on the monitored location of the trader;
compare, using the processor, the presence state of the trader with a risk threshold; and
triggering, using the processor, a risk mitigation strategy including a risk mitigation action, wherein the triggered risk mitigation action is determined based on the comparison between the presence state of the trader and the risk threshold.

19. The system of claim 18, wherein the processor further determines an occurrence of a risk event, wherein the monitoring of the location of the trader occurs in response to the occurrence of the risk event.

20. The system of claim 18, wherein the risk mitigation action includes actions selected from the group consisting of: providing a notification to a risk administrator, automatically flattening a position held by the trader, moving a working order, deleting a working order, triggering submission of a trading strategy algorithm, and assigning an order to a second trader.
